(19) United States
(12) Patent Application Publication
(10) Pub. No.: US 2015/0274054 A1
(43) Pub. Date: Oct. 1, 2015

(54) VEHICLE FOR THE TRANSPORT OF LIQUIDS AND/OR SOLIDS

(71) Applicant: Josef Fliegl, JR., (US)

(72) Inventor: Josef Fliegl, SR., Kastl (DE)

(21) Appl. No.: 14/669,309

(22) Filed: Mar. 26, 2015

(30) Foreign Application Priority Data
Mar. 26, 2014 (DE) 20 2014 101 421.7

(51) Int. Cl. B60P 1/00; B60P 3/22; B62D 21/16

(52) U.S. Cl. CPC B60P 1/006; B62D 21/16; B60P 3/2225

(57) ABSTRACT

A vehicle for the transport of liquids and/or solids has at least a first liquids tank and at least one solids container, a vehicle frame, and a chassis. The first liquids tank is an integral part of the vehicle frame and the solids container has an unloading

### CROSS REFERENCE TO RELATED APPLICATIONS

This application claims the benefit of German Patent Application No. 20 2014 101 421.7, filed Mar. 26, 2015, and incorporated herein by reference.

### TECHNICAL FIELD

The invention concerns a vehicle for the transport of liquids and/or solids with at least a first liquids tank and at least one solids container.

### BACKGROUND OF THE INVENTION

A vehicle superstructure is known from DE 20 2009 017 639 U1 for the transport of liquids and/or solids, wherein a liquids tank is fastened to the chassis and on top of the liquids tanks is arranged at least one tiltable solids container. Due to this arrangement, a relative large overall height of the vehicle must be tolerated and also the fill volumes of liquids tank and solids container are correspondingly restricted. Furthermore, the tilting mechanism for the solids container arranged on top of the liquids tank is correspondingly expensive. The free space above the vehicle which is needed for the tilting is also a drawback in many applications.

Therefore, the problem which the invention solves is to further develop the vehicle for the transport of liquids and/or solids with at least a first liquids tank and at least one solids container so that the available design space is utilized optimally yet still providing an easy unloading capability for the solids container.

### SUMMARY OF THE INVENTION

According to the invention, this problem is solved by the features of claim 1. Advantageous embodiments are described in the other claims.

The vehicle of the invention for the transport of liquids and/or solids has at least a first liquids tank and at least one solids container, a vehicle frame, and a chassis. The first liquids tank is an integral part of the vehicle frame and the solids container has an unloading opening as well as a discharge mechanism for self-unloading of the solids.

Thanks to the configuration of the liquids tank as an integral part of the vehicle frame, the available design space can be optimally utilized, so that the overall cargo volume can be increased accordingly for the same vehicle height. Moreover, the liquids tank can be arranged further below, so that more structural space is available for the at least one solids container. Thanks to the integration of the liquids tank in the vehicle frame, the weight of the vehicle itself can furthermore be reduced. Moreover, the vehicle has a lower center of gravity, which has a positive impact especially on the road handling.

According to one preferred embodiment of the invention, the discharge mechanism has a sliding floor, a scraper floor or a push-off wall which can move in the direction of the unloading opening. A configuration of the discharge mechanism as a tilting mechanism is also conceivable. Moreover, the unloading opening is arranged at a rear end of the vehicle.

The providing of a push-off wall for the discharging of the solids has the advantage that a discharging of the solids is even possible if sufficient room is not available above the vehicle for a tilting of the solids container.

The solids container is preferably bounded by two side walls, a rear wall arranged in the area of the unloading opening, preferably able to pivot, and the push-off wall. If necessary, a roof can also be provided, in order to protect the materials from weather factors from above.

In one preferred embodiment of the invention, the discharge mechanism is designed as a two-stage one, a first stage being formed by a sliding floor, which together with the push-off wall can move in the direction of the unloading opening, and the second stage is formed by the push-off wall, which can move relative to the sliding floor.

In order to make optimal use of the available structural space, the first liquids tank is bounded at the top by the vehicle floor, which at the same time also forms at least one part of the floor of the solids container. The solids container is therefore advisedly arranged on the first liquids tank.

If the fill volume of the first liquids tank is not enough, at least one second and possibly a third liquids tank can be arranged in the front region of the vehicle. For example, it is possible to arrange the second and possibly the third liquids tank in the front region of the vehicle on the first liquids tank, while the first and the at least one second or third liquids tank can be in communication with each other for the transfer of liquid.

According to another embodiment of the invention a free space is provided between the second and the third liquids tank transversely to the lengthwise axis of the vehicle, while the discharge mechanism has a driving mechanism which partly protrudes in this free space. This produces an especially compact arrangement making optimal use of the available structural space. For filling the liquids tank, the second and/or third liquids tank advisedly has a fill opening, while the second and/or third liquids tank is in communication with the first liquids tank by at least one connection opening. Furthermore, the first liquids tank can have at least one outlet opening at the rear end of the vehicle. The first liquids tank is designed for this purpose so that the outlet opening is situated at the lowest point when the vehicle is parked on a horizontally oriented surface and a fast and easy emptying is possible in this way. The vehicle is preferably designed as a trailer, especially a semitrailer. But a design as a truck is also conceivable.

### BRIEF DESCRIPTION OF THE DRAWINGS

Further embodiments of the invention shall be explained more closely by means of the following description and the drawing.

In the drawings are shown

FIG. 1 a three-dimensional representation of the vehicle for transport of liquids and/or solids,

FIG. 2 a side view of the vehicle in FIG. 1,

FIG. 3 a top view of the vehicle in FIG. 1,

FIG. 4 a schematic sectional representation along line IV-IV of FIG. 2 and

FIG. 5 a schematic sectional representation along line V-V of FIG. 2.

### DETAILED DESCRIPTION OF ILLUSTRATIVE EMBODIMENTS

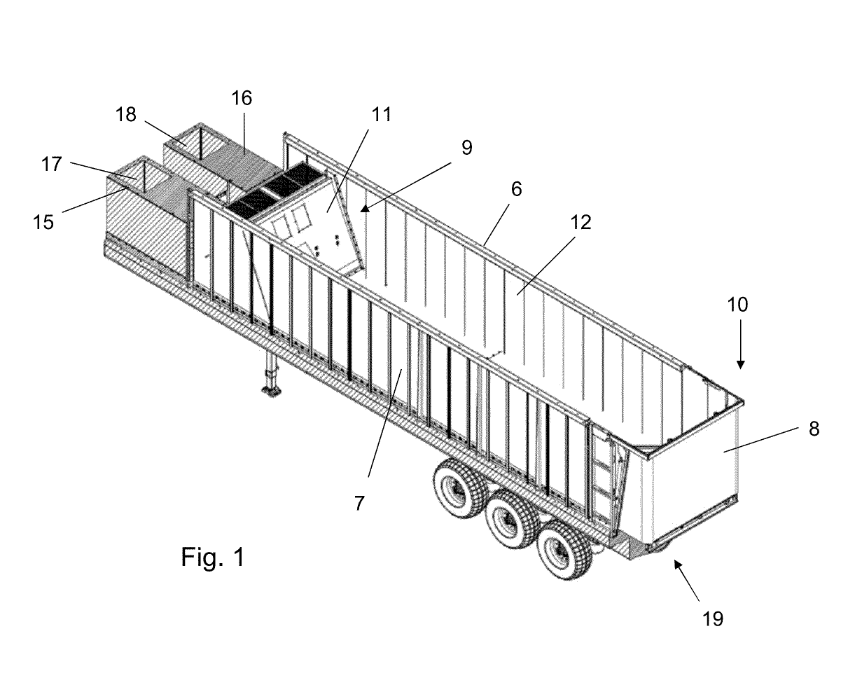

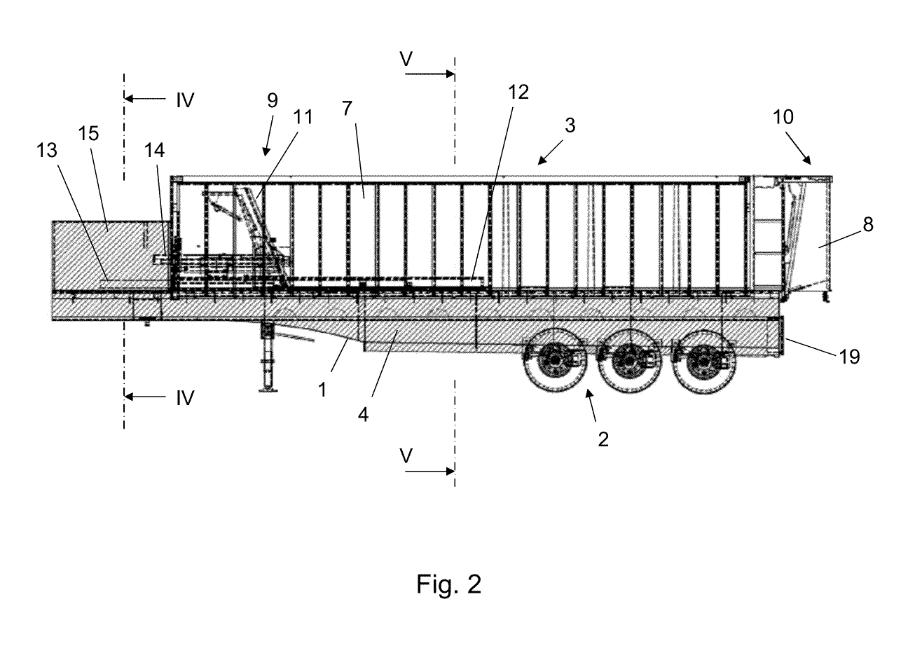

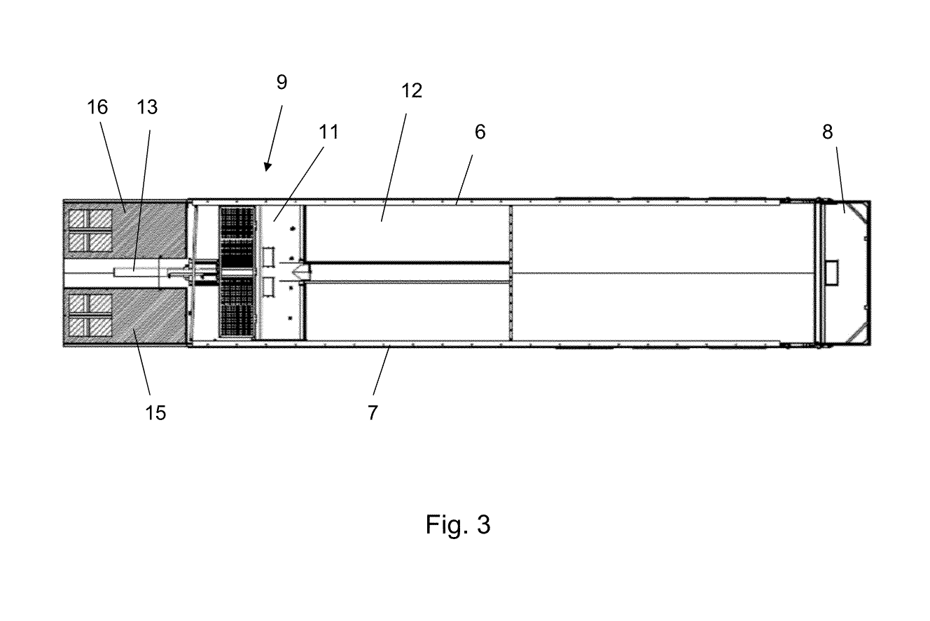

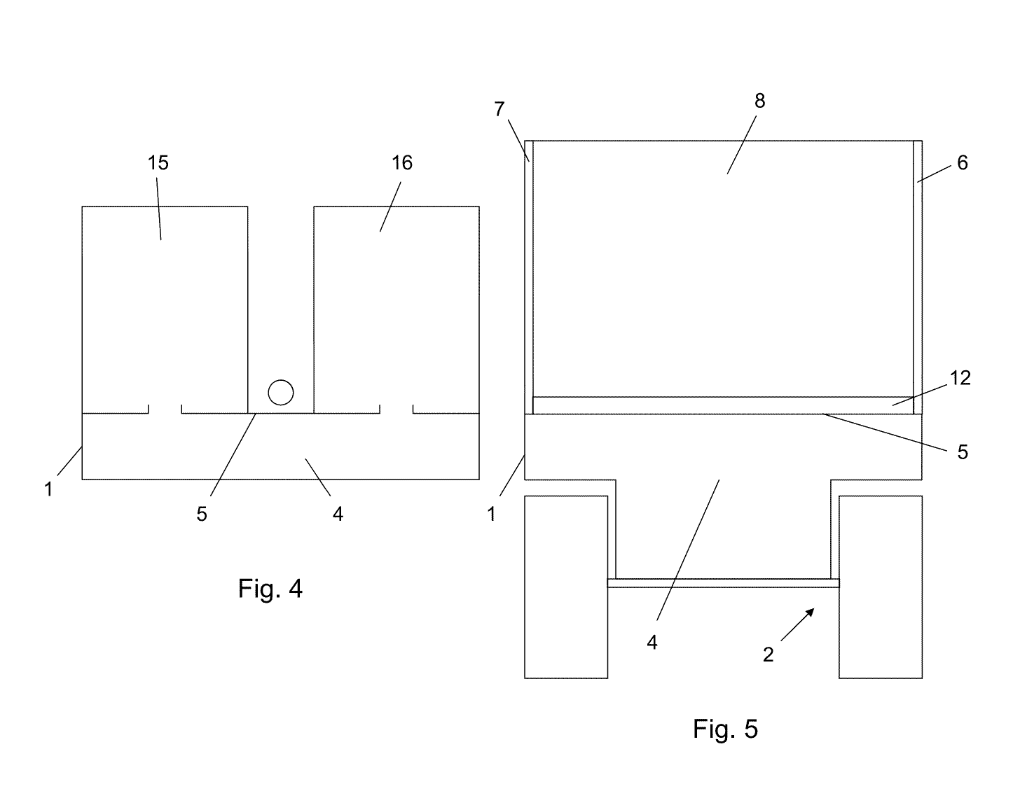

The vehicle represented in FIGS. 1 to 5 is a trailer, especially a semitrailer, having a vehicle frame 1, a chassis 2 and a solids container 3. Furthermore, a first liquids tank 4 is provided, which is configured as an integral part of the vehicle frame 1. It is evident from the schematic sectional views of FIGS. 4 and 5 that the vehicle frame 1 at the same time forms the walls of the first liquids tank 4. The top closure of the liquids tank 4 is formed by the vehicle floor 5, which at the same time also forms a portion of the floor of the solids container 3.

The solids container in addition to the floor formed by the vehicle floor 5 has two side walls 6, 7, an unloading opening 10 closed by a rear wall 8 designed to be pivotable, and a discharge mechanism 9 for the discharging of the solids. The discharge mechanism 9 comprises a push-off wall 11 which can move in the direction of the unloading opening. Furthermore, the discharge mechanism is two-staged, the first stage being formed by a sliding floor 12, which can move together with the push-off wall 11 in the direction of the discharge opening 10. The second stage is formed by the push-off wall 11, which can move relative to the sliding floor. If the solids container 3 is fully loaded, the sliding wall 11 is in the position shown in FIGS. 1 to 3. For the discharging of the solids, first of all the unloading opening 10 is opened by tilting up the rear wall 8. Now the sliding floor 12 is moved together with the push-off wall 11 in the direction of the unloading opening 10, until the front edge of the sliding floor 12, facing the unloading opening 10, is coupled to the unloading opening. For the further discharging, the sliding wall 11 is then moved relative to the stationary sliding floor 12 in the direction of the unloading opening 10. For the displacement of the sliding floor 12 and the push-off wall 11 there is provided a separate drive mechanism 13, 14 for each in the sample embodiment shown, formed here by hydraulic cylinders. Yet other drive mechanisms are entirely possible, such as a drive unit with circulating chains or cables.

In the driving direction in front of the solids container 3 a second and third liquids tank 15, 16 are arranged on the vehicle floor 5. In this way, the fill volume for liquid can be increased accordingly. Between these two liquid tanks 15, 16 is provided a free space, into which at least one of the drive mechanisms 13, 14 protrudes. Both the second and the third liquids tank 15, 16 are provided with a fill opening 17, 18, through which the liquid can be filled. The second and third liquids tank are in communication with the first liquids tank 4 by corresponding connection openings, not otherwise represented. An outlet opening 19 is provided at the rear end of the vehicle for draining the liquid contained in the liquids tanks.

1. A vehicle for the transport of liquids and/or solids, especially bulk goods, with at least a first liquids tank and at least one solids container, a vehicle frame, and a chassis,
characterized in that the first liquids tank is an integral part of the vehicle frame and the solids container has an unloading opening as well as a discharge mechanism for self-unloading of the solids.

2. The vehicle according to claim 1, characterized in that a discharge mechanism comprises a push-off wall able to move in the direction of the unloading opening.

3. The vehicle according to claim 1, characterized in that the solids container is bounded by a floor, two side walls, a rear wall arranged in the area of the unloading opening, preferably able to pivot, and the push-off wall.

4. The vehicle according to claim 3, characterized in that the discharge mechanism is designed as a two-stage one, a first stage being formed by a sliding floor, which together with the push-off wall can move in the direction of the unloading opening, and the second stage is formed by the push-off wall, which can move relative to the sliding floor.

5. The vehicle according to claim 1, characterized by a vehicle floor fashioned as part of the first liquids tank, which at the same time also forms part of the floor of the solids container .

6. The vehicle according to claim 1, characterized in that the solids container is arranged on the first liquids tank.

7. The vehicle according to claim 1, characterized in that at least one second liquids tank is arranged in the front region of the vehicle on the first liquids tank.

8. The vehicle according to claim 1, characterized in that a second and a third liquids tank is arranged in the front region of the vehicle on the first liquids tank.

9. The vehicle according to claim 7, characterized in that the first and the at least one second liquids tank are in communication with each other for the transfer of liquid.

10. The vehicle according to claim 8, characterized in a free space is provided between the second and the third liquids tank transversely to the lengthwise axis of the vehicle and the discharge mechanism has at least one driving mechanism which partly protrudes in this free space.

11. The vehicle according to claim 7, characterized in that the second and/or the third liquids tank are arranged in front of the solids container on the first liquids tank.

12. The vehicle according to claim 7, characterized in that the second and/or the third liquids tank has at least one fill opening and is in communications with the first liquids tank by at least one connection opening.

13. The vehicle according to claim 1, characterized in that the first liquids tank has at least one outlet opening at the rear end of the vehicle.

14. The vehicle according to claim 1, characterized in that the vehicle is designed as a trailer, especially a semitrailer.

15. The vehicle according to claim 1, characterized in that the unloading opening is arranged at a rear end of the vehicle.
